(19) United States
(12) Patent Application Publication
(10) Pub. No.: US 2020/0026535 A1
(43) Pub. Date: Jan. 23, 2020

(54) Converting Presentations into and Making Presentations from a Universal Presentation Experience

(71) Applicant: PearCircuit LLC d/b/a Liven, Fishers, IN (US)

(72) Inventors: Michael S. Young, Fishers, IN (US); Brendan L. Michaelsen, Fishers, IN (US); Michael E. Cloran, Fishers, IN (US)

(73) Assignee: PearCircuit LLC d/b/a Liven, Fishers, IN (US)

(21) Appl. No.: 16/518,232

(22) Filed: Jul. 22, 2019

Related U.S. Application Data
(60) Provisional application No. 62/701,332, filed on Jul. 20, 2018.

(51) Int. Cl. G06F 9/451

(52) U.S. Cl. CPC G06F 9/451

(57) ABSTRACT

A computer-based system processes presentations into a universal display protocol with full fidelity to the original files. The system launches a presentation utilizing native presentation software on a recorded machine, sends a series of common user actions to the presentation software, detects the beginning and end of each action's effect, and records each action's associated video segment for future playback. Playback involves playing the recorded video segments in response to user inputs received during that playback.

### REFERENCE TO RELATED APPLICATION

This application is a nonprovisional application which claims benefit of pending U.S. Provisional Patent Application Ser. No. 62/701,332, filed on Jul. 20, 2018, titled CONVERTING PRESENTATIONS INTO AND MAKING PRESENTATIONS FROM A UNIVERSAL PRESENTATION EXPERIENCE.

### BACKGROUND

Almost every presentation given today contains a digital component—a PowerPoint presentation, a Keynote slide deck, an animated presentation in Prezi, or even a simple video. In fact, these digital elements are so essential to most presentations that they are often simply called “presentations” themselves.

Unfortunately, presenters face significant challenges in ensuring their presentations are displayed the way they intended.

Presentations are, by their nature, meant to be shared and given to many different people. To achieve this, a presenter may need to transmit his presentation to a computer with a different operating system to present it. Or the computer used to present may have different presentation software, or an old version of the presentation software installed, or be missing fonts, stylings, animations, videos or additional important elements that were incorporated in the presentation the author's computer. All of these are “compatibility issues,” and each can wreak havoc on the intended results of a presentation. Each can cause slides to appear stretched or warped and make text illegible, videos unplayable, and animations non-functional—if the file can be opened and played at all.

There are several types of compatibility issues which merit additional discussion.

One type of compatibility issue is a “cross-device problem.” A cross-device problem arises from the split realities of mobile and desktop computing. Mobile devices (which often run on unique operating systems and rarely possess the same presentation software as desktop computers) are unable to play many presentation files without special downloads, despite the fact that a significant portion of modern computer usage occurs on mobile devices. The inability of many mobile devices to play presentations without extra downloads or modifications renders many presentations unviewable until a recipient or participant can “get back to their desk,” at which point they may have lost interest, become distracted, or simply forgotten about the presentation.

A second type of compatibility issue is a “combined-deck problem.” Those wishing to create events with multiple speakers often desire to collect all the speakers' presentations together into a single presentation file to avoid awkward transitions (showing their personal desktop, tangling projector cables unplugging one laptop to plug in another, etc.). To an audience, a single deck of combined slides is simply much smoother than individual decks for each speaker.

Unfortunately, organizers regularly struggle to combine content from multiple speakers into a single unified presentation because there is limited cross-compatibility between each speaker's “presentation builder of choice” (PowerPoint, Keynote, Prezi, etc.).

An organizer wishing to organize a smooth event with a combined deck has a single, unpalatable half-solution at their disposal—manually migrating or recreating each build, bullet, video, and transition from files made in “foreign” presentation programs in their own preferred “native” presentation program. This reformatting process introduces sizable and anxiety-inducing alternations to the source material, and is often performed by organizers at the last minute, as few speakers send in content for review in a timely manner. Thus, there is a large amount of tedious labor involved, as well as a great deal of stress and a high probability of error.

A third class of compatibility issues is a “shared presentation problem.” Existing presentation technology falls short when it comes to controlling shared presentations—presentations either sent as email attachments to interested parties, embedded on a presenter's website or blog in the style of webinar content. Shared presentations are difficult to control simply because few presentation tools have developed technology for this use case.

This void has led to the use of numerous desktop-sharing conferencing applications, such as GoToMeeting, Google Hangouts, etc. However, these conferencing tools (which typically involve one participant sharing their screen) have their own drawbacks. Numerous meetings have ground to a halt as new members spend time installing software to join, only to have the presenter entirely embarrassed when they forgot to turn off their messaging system and embarrassing messages appear on their screen for every participant to see. Or, worse yet, a presenter may forget to close their email tab and accidentally display critical information about the very people with whom they are meeting.

In many cases, the burden of adopting special and complex meeting software to solve the “shared presentation problem” has prevented meetings from happening at all, leading to missed business and educational opportunities.

What attempts have been made to solve these and other compatibility issues?

Adobe made enormous progress in sharing documents with full fidelity across numerous platforms. However, when it came to presentations, Adobe's PDF solution either “flattened” presentations into a series of static images (and by doing so forfeited the ability to handle full-fidelity presentations that encompass motion, audio, and a range of possible user actions) or forced authors and participants to download special suites of tools to rebuild animations in a new format (which means that users would have been better off not converting their presentations to PDF in the first place). While users benefitted greatly from Adobe winning the war for viewing and printing full-fidelity documents as intended, its inability to truly solve compatibility for rich and interactive presentations has left users bereft of a way to share and experience their presentations in a consistent way, regardless of device or platform.

Web-based projects have also arisen to address challenges in the presentation space. Web-based slide-sharing services like SlideShare attempt to make presentations shareable and embeddable online, but in fact require the user to upload their files as PDFs. As mentioned before, PDF files are static image files and do not allow for animations or video. Presentations that use animations to selectively reveal and remove content need to be totally reworked to fit this format. Additionally, presentations that require video or audio cannot be converted to PDFs without total loss of that content. Therefore, services that require PDF uploads are not truly capable of sharing many presentation files without significant modifications.

Other web-based platforms (e.g., Google Slides, Prezi) require users to fully create their presentations on their services to guarantee full fidelity to the author's intentions. However, many presentations are not natively composed in these platforms, and converting from another native presentation format into a Slides or Prezi presentation results in the same cross-compatibility issues historically seen in desktop applications, and those issues require time and attention to correct.

In sum, many presenters would greatly benefit from a new system that allows them to upload files of various kinds and share and present them anywhere with accurate visuals and fully functional animations, video, and audio on any modern platform. Some such systems will result in output that confidently displays the input presentation as originally intended. Some systems will provide output that is sharable and presentable on any platform. Some systems would eliminate many of the challenges presenters face in distributing their presentations, and in effect would function as a universal presentation experience in which anyone in the world, on any device, could fully experience a presentation in a consistent, rich way with full fidelity to the author's intentions.

### SUMMARY

By converting largely incompatible presentations into a proprietary Universal Presentation Experience (UPE) format as described herein, some embodiments of the disclosed system generate the exact, desired presentation on nearly any modern platform, including via link sharing, on mobile devices, etc. Additionally, some embodiments of the UPE format allow control and display to be separated from any one individual device and to instead be controlled from or displayed to many devices simultaneously (a “present from the cloud” UPE).

In some embodiments, UPE-format files contain a specialized video file and a map of actions and their associated video segments. The video file and map can be used to simulate a presentation experience as simple as advancing or reversing slides with a clicker, or as complex as simulating more advanced presenter actions such as jumping to specific slides or controlling results via hotspots on an image or page.

Such a map can be generated beforehand by a “presentation conversion algorithm,” or PCA. The goal of some PCAs is to determine which user inputs to simulate and to then determine the intended effect of those inputs and properly record them into the UPE video file and map. One method to do this involves analyzing the percentage change of constituent pixels (or, in the case of audio, changes in speaker output levels generated by the presentation software) between time-offset snapshots (individual frames of the recording), from which it is possible to determine whether an animation, sound, or video is playing. Other implementations may include API-based and other notifications of the presentation software, operating system artifact detection, looping animation detectors, and deep learning neural networks with or without human assistance.

An exemplary PCA that runs on video screen capture can be applied across many different input files (PowerPoint, Keynote, Google Slides, Prezi, PDF, images, videos, etc.) with great ease and can support a wide variety of documents. There is no requirement to identify objects in the constituent file, to layer different tracks of sound, or perform any “comprehension” tasks to interpret and track which elements exist within a presentation. Instead, it may be sufficient merely to examine periodic snapshots of a presentation being played back on a screen and to analyze those snapshots for evidence that the impact of the associated user action has completed.

Furthermore, by also implementing certain video processing techniques, it is possible to generate several videos of different qualities from the same PCA output, enabling selection between high-resolution and lower-resolution UPE playback as different situations demand.

### BRIEF DESCRIPTION OF THE DRAWINGS

While the specification concludes with claims that particularly point out and distinctly claim the invention, it is believed the present invention will be better understood from the following description of certain examples taken in conjunction with the accompanying drawings, in which like reference numerals identify the same elements and in which:

FIG. 1 is a block diagram of a system for generation of a universal presentation experience file.

FIG. 2 is a process flow diagram illustrating conversion of a presentation using the system of FIG. 1.

FIG. 3 is a series of simulated screenshots illustrating various configurations of a player of universal presentation experience files.

FIG. 4 is a flowchart illustrating setup and operation of a presentation conversion.

FIG. 5 is a block diagram illustrating components and playback of a universal presentation experience file.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DESCRIPTION

High-Level Description

In this example implementation, a user uploads a file through an online uploader or shares a link to his or her presentation if it is built in an online presentation builder. The file then enters a queue for conversion.

The presentation converter launches the presentation on a well-provisioned virtual desktop, launches the presentation software that is native for the presentation to be converted and begins screen-capturing the entire output. It then sends a series of standard user interactions to that software and marks the beginning and end of the captured video segment that represents the presentation software's response to each action. The resulting map of actions and captured video segments creates the Universal Presentation Experience (or UPE) needed for the interactive playback on various modern video and JavaScript-enabled platforms.

Playback of the UPE in some instances/implementations is asynchronous, wherein the viewer is presented with the introductory image and/or video from the original presentation, then provides his or her desired input, which prompts playback of the recorded audio and video that the presentation produced in response to that particular input according to the UPE map. The viewer proceeds through the presentation providing his or her input to control a presentation at will, each time seeing the recorded audio and video until the presentation is complete.

Playback of the UPE in other instances/implementations is synchronous, wherein one or more presenters access a presenter interface that accepts control input, and both the presenters and optionally one or more viewers are presented with the response of audio and video. In some embodiments, information is collected from one or more presenters and/or viewers, such as login information for data collection or security purposes, answers to survey questions, questions for the presenter(s), and the like as will occur to those skilled in the art.

### DETAILED DESCRIPTION

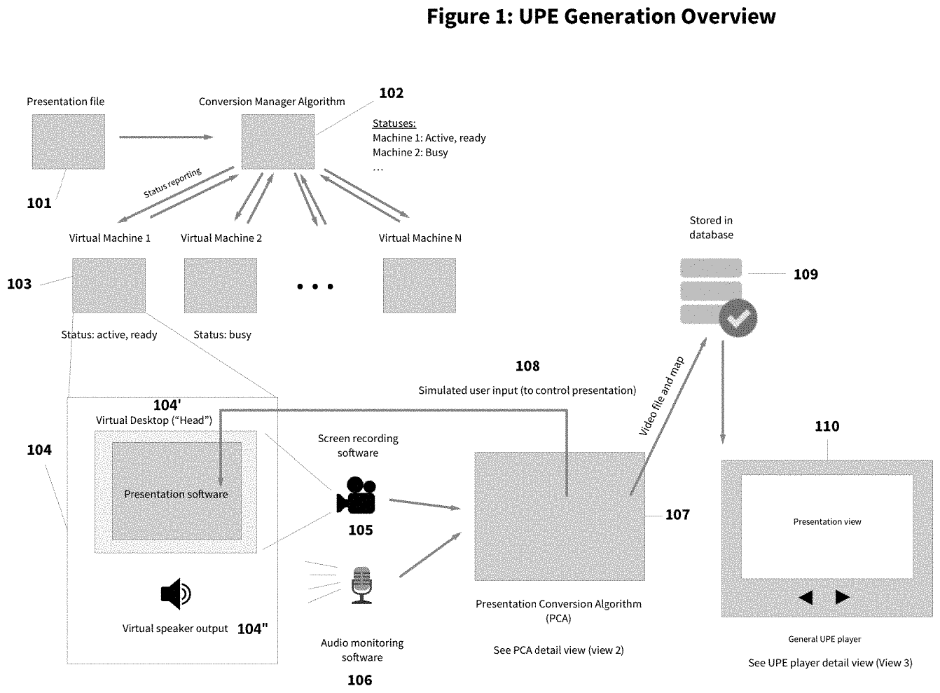

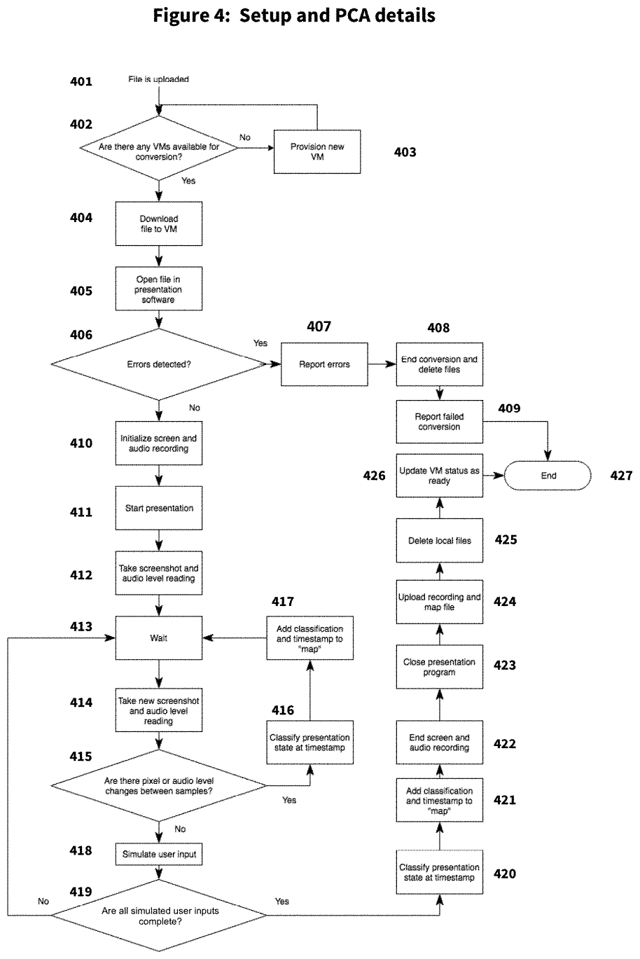

With reference to FIG. 1 and ongoing reference to FIG. 4, in this exemplary embodiment, a conversion queue interfaces with a conversion manager algorithm (“CMA” or “manager”) 102, which monitors and reports the status (“booting up,” “idle,” “occupied,” “crashed,” “off,” etc.) of one or more virtual machines (VMs) 103, each of which is at any given time assigned a number of presentations 101 to convert. The CMA 102 may disqualify a VM 103 as a “candidate machine” if an error or failure has been detected, or if a VM 103 reports a status such as “occupied” (already in the process of converting a presentation) or “crashed.” The manager 102 may also initialize (403) new VMs 103 or turn off already-initialized VMs 103 depending on the volume or size of presentations 101 that need conversion (401). The CMA 102 may also assign certain presentations 101 to certain VMs 103 based on presentation metadata, such as the file type of the presentation 101, the size of the presentation 101, or other preferences. As a function of these considerations, the CMA 102 will assign the queued file 101 to an appropriate VM 103 when it determines (402) one is available or, alternatively, will launch a new instance (403) to handle the conversion.

Then, in this exemplary embodiment, the presentation 101 is downloaded (404) to the VM (or, in the case of a provided link, opened in a web browser in the VM 103 and accessed via URL) that has already been set up to include the relevant presentation software (405) and many different fonts and other resources. The VM 104 has a simulated screen output (head) 104′ that mimics what would be on a screen if one were present, and it has simulated audio output 104″ that mimics sound that would be coming through the speakers if the VM 104 were a normal computer plugged into a monitor and speakers. Simultaneously, the presentation conversion algorithm (PCA) 107 is activated.

The PCA 107 may command the VM to wait for a predetermined duration to make sure the file opened correctly (406). If the presentation software throws errors at this time (e.g., “the file is password protected and can't be opened,” “the file is corrupted”), the PCA 107 may detect these errors (407), report them (409) to the CMA 102, and perform appropriate actions such as deleting the file (408), removing it from the queue, and giving it a “failed convert” status. Failure detection may be achieved by multiple techniques as will be appreciated by those familiar with this technology area, including for example API integration with the program used to present the presentation, recognizing error messages using CSS selectors, or analysis of the characteristic visual elements of the many possible error messages.

If no errors are detected (406), the PCA 107 may report that no errors were found and commence the next step in the conversion process by beginning a recording (410) of the head (screen recording) 105 and audio 106 simulated by the VM 104.

After recording has started, the PCA 107 starts the presentation (411) in presentation software 104′, takes a screenshot and audio reading (412), begins recording, and waits (413). PCA 107 takes another snapshot and audio reading (114) and compares the pixels in the respective snapshots and looks for audio changes between the samples (415). If any are found, PCA 107 classifies (416) the presentation state at the letter timestamp as “different” and adds that classification and timestamp (417) to the UPE “map” file in database 109 as it goes back to waiting (413) for the appropriate time for the next snapshot.

When PCA 107 determines that the presentation is no longer changing (415; see below), PCA 107 begins sending (418) various standardized user actions 108 to the presentation software 104′ and continues recording the screen 105 and audio 106 outputs, whether by using an API of the presentation software, simulating input to a web browser running in the VM 104, simulating a user action through the operating system running in the VM, or other technique as would occur to those skilled in the art. The PCA 107 analyzes the resulting video output to determine when the effect of the user action has run its course, records the video segment times, and issues the next (simulated) user action 108 to the presentation software. These actions may also not be simulated, but instead take direct input from the user who uploaded the presentation.

When PCA 107 determines (419) that all simulated user inputs have been attempted and the presentation has ended, it classifies the presentation state at the relevant timestamp(s) (420), adds (421) the classification and timestamp to the UPE “map” file in database 109. Screen 105 and audio 106 recording are terminated (422), and the presentation program 104′ on the VM 104 is closed (423). The audio/video recording and UPE “map” file are stored/uploaded (424) (e.g., to a server or cloud storage facility), and local files are deleted (425). Termination of the PCA 107 triggers CMA 102 to update the VM status as “ready” (426), and the process ends (427).

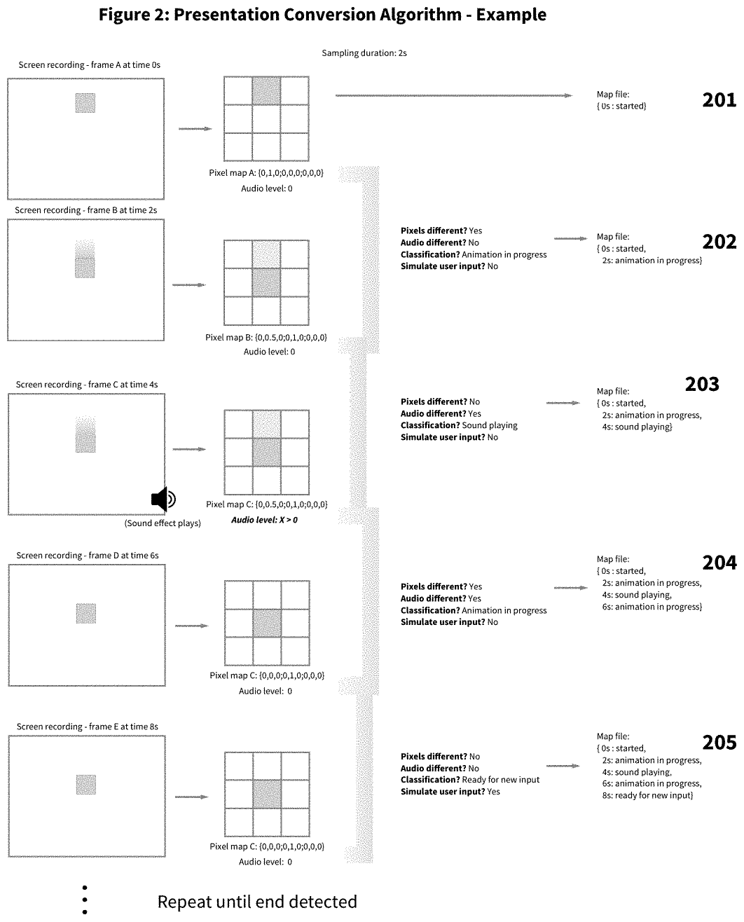

Turning to FIG. 2, in one embodiment of the technology, this analysis and detection is done through comparison of various “snapshots” 201, 202, et seq. of the screen capture video 104′. The comparison is a high-level comparison which seeks to establish the percentage change in pixels between the two snapshots above a certain “noise threshold” (an empirically determined measure used to reduce false change detections, as there is always a small chance that the rendering of two images intended to be identical may still have a trivial number of different pixels—and thus a non-zero percentage difference—due to imperfections, artifacts, or inconsistencies in screen rendering, capture, and comparison software). The result of this comparison process is a change assessment (“different,” “not different,” “can't determine,” etc.) assigned to the timestamp at which the second snapshot was made. A similar analysis may be made for audio being simulated by the virtual speaker output 104″ of VM 104.

This comparison process enables the PCA 107 to determine whether the presentation displayed has changed in any substantial way during the interval between the first and second snapshots 201, 202. If the difference between the two slides exceeds the noise threshold, then the system infers that an animation, video, motion, or sound is being played. The PCA 107 records the timestamp and change assessment to the UPE “map file” in database 109.

Then the PCA 107 waits for another interval, takes another snapshot, and performs another comparison. Still more comparisons may be made to additional snapshots to improve accuracy of the change assessment.

If the change assessment is “not different”—which means the percentage difference of pixels is below the noise threshold—the PCA 107 again notes the timestamp and makes the classification “ready for next action.”

If a “ready for next action” classification is made, the PCA 107 simulates a keypress or other user input 108 on the virtual machine 104. This simulated user input 108 may be similar to hitting the spacebar, pressing the right arrow, or clicking in traditional presentation software programs. This function may advance the presentation to the next slide or otherwise change the state of the presentation 101, such as by moving “up” or “down” in a non-linear presentation, starting or stopping an embedded video, incrementing a counter, or other change as will occur to those skilled in the art

After the simulated user input 108, the PCA 107 makes another change assessment and records the assessment results and timestamps in the UPE map file in database 109.

The PCA 107 may also reach a classification of “slideshow has ended” through numerous means, including for example detecting that a snapshot contains “end of slideshow, click to exit,” or by having many snapshots over a series of intervals and inputs with a “no difference” classification (suggesting there are no more slides left to play), or by receiving an event from a presentation program's API indicating the final slide has been reached. At this point, the PCA 107 will finalize the UPE map, close the presentation 101, and stop recording the specialized UPE screen capture video 104′.

In this illustrative embodiment, the screen recording video and the map that result from the work of PCA 107 are stored in a cloud-based database 109, and the VM 104 reports a successful conversion status to the CMA 102. The PCA 107 may also “clean up” the VM 104 by deleting any files left over from the conversion process from the VM 104 once the cloud storage is completed successfully.

In this embodiment, to give the recorded presentation, the outputs of PCA 107 are used to make a web-based video player 110 with controls to navigate the presentation—the UPE, or “universal presentation experience.” Hitting “forward” on the controls navigates to the next “key moment” (animation, new slide, etc.) by playing the video forward from the current timestamp to the next recorded timestamp in the map. Going “backward” is the reverse of this, playing the preceding video backward from the current timestamp in the map to the previous one. The player 110 may also include non-linear elements (such as chaptering, rewinding, etc.) or non-slide elements (such as interactive polls, surveys, ads, or forms), which may be inserted as a layer over the video or as an additional video segment between split segments of the main video.

A “desynchronized” presentation may occur by giving control of the player to any user who loads a particular web page with a simple UPE player 110 on it. Any person with access to the UPE player 110 and the UPE map can thus control and play the presentation at their convenience, at their own pace, and using a wide variety of devices with even a minimal set of capabilities.

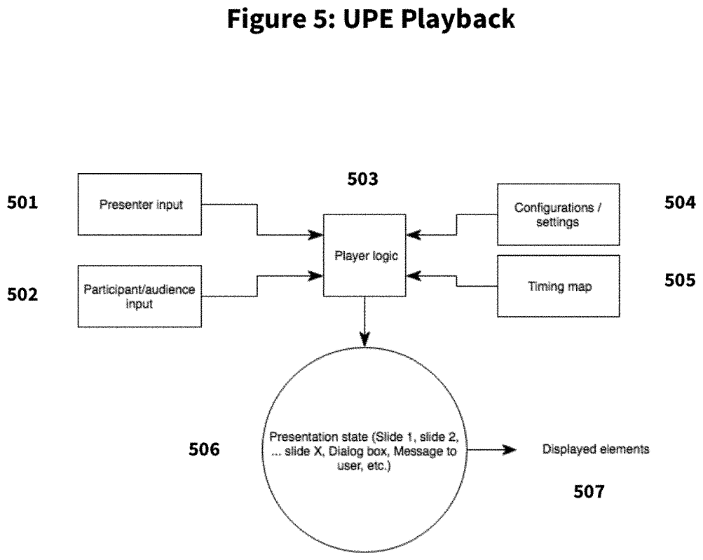

Other implementations and circumstances will implement a “synchronized” presentation in which control is assigned to a single user who, by updating the status of (e.g., providing input to) the player 110 on their webpage, triggers an update to other participants' players 110 as well. With reference to FIG. 5, this input 501, input from the participant(s)/audience 502, configurations 504 set by various users, and the timing map 505 saved during conversion of the presentation are inputs to player logic 503, which controls the state 506 of the shared presentation, which produces the elements 507 displayed to each user.

In this embodiment, the resulting player 110, which is simple enough to be fully implemented in JavaScript (a language with near universal browser and operating system support), plays back the presentation with perfect fidelity to the original style, fonts, animations, videos, etc. Such a player 110 can be embedded and the presentation shared across many different platforms, as it's simply playing a video (a filetype with wide cross-platform support) instead of playing a specialized presentation file (with limited cross-platform support). The participant or viewer of the presentation is given a universal and consistent experience across all platforms and devices, and the experience may even be universal in the additional sense of being synchronized with the state of the presenter's deck in a synchronized presentation. Thus, this conversion process results in a Universal Presentation Experience (UPE) for anyone to view any presentation on any device with total consistency and full, rich, animations, video and audio.

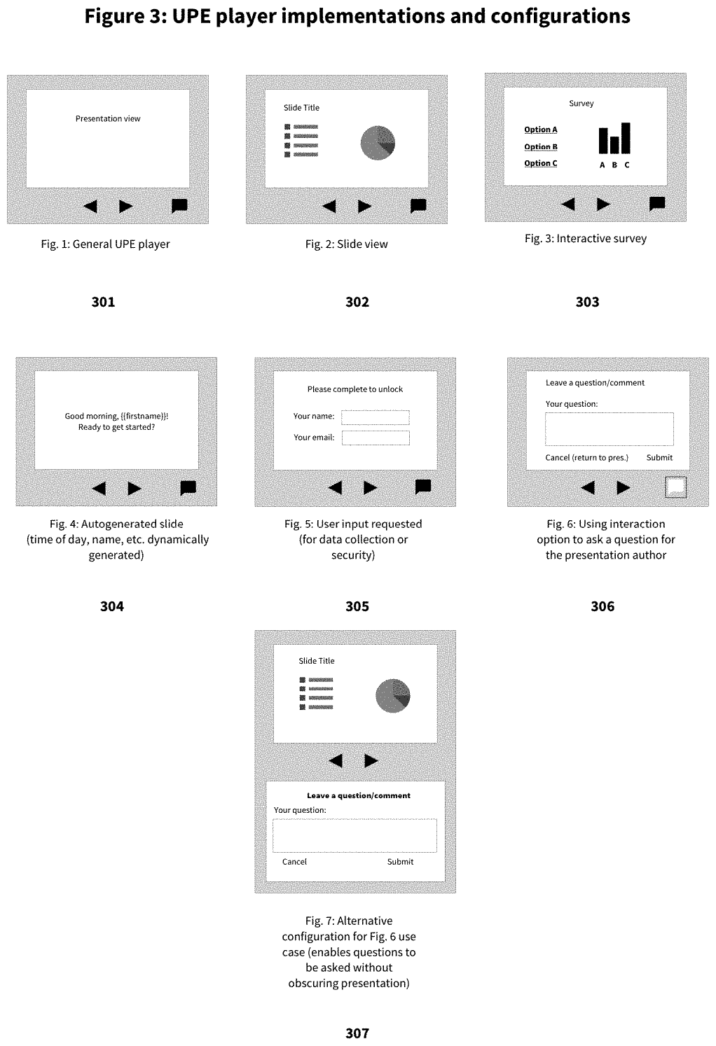

Various other forms of the player 110 in this exemplary embodiment are shown in FIG. 3. A simple UPE player 301 includes controls to advance, go back, and comment on the presentation. A slide view 302 includes traditional presentation content in the main portion of the player's interface, while an interactive survey can be taken in view 303. Auto generated slide view 304 includes one or more fields that are dependent on dynamic data, such as the time of day, name of the participant and/or presenter, or other information as will occur to those skilled in the art.

In some implementations, the presenter/presentation/player 110 can request input from the viewer for data collection or security as shown in view 305. In others, the viewer can provide a question or other input to the presenter or the presentation's author as illustrated in view 306. An alternative configuration enables viewers to ask questions without obscuring the presentation content as shown in view 307.

What is claimed is:

1. A computer-based system for the processing of presentations into a universal display protocol with full fidelity to the original files by:
a. launching presentation utilizing native presentation software on a recorded machine;
b. sending a series of common user actions to the presentation software;
c. detecting the beginning and end of each action's effect; and
d. recording each action's associated video segment for future playback.
